(19) United States
(12) Patent Application Publication
(10) Pub. No.: US 2012/0153245 A1
(43) Pub. Date: Jun. 21, 2012

(54) FURNITURE LIFTING DEVICE

(76) Inventors: David A. Zloch, Indiatlantic, FL (US); Joseph S. Zloch, Melbourne, FL (US)

(21) Appl. No.: 12/972,814

(22) Filed: Dec. 20, 2010

(51) Int. Cl. B66F 3/24; B66F 3/25; B66F 3/00

(52) U.S. Cl. 254/93 R; 254/133 R

(57) ABSTRACT

A furniture lifting device (1) having a hydraulic jack (6) extending upward from a rear portion (3) of a device base (2). A guide (13) located on the jack extends forward towards a U-shaped front portion (4) of the device base. A bracket (14), which is preferably substantially U-shaped, is slidably attached to the guide. A foot (15) extends from a bottom end (16) of the bracket towards the front portion of the device base so that the foot is perpendicular to the bracket. The foot may be placed under the edge of a piece of furniture in order to lift the furniture off of the ground. A substantially tubular post (17) extends upward from the top of the bracket and the jack. The post may be placed under furniture, such as table tops or desk tops, in order to lift the furniture off the ground. An extension arm (23) located inside the post telescopes from the post, thereby allowing a user to adjust the height of the device to accommodate taller pieces of furniture.

### BACKGROUND OF THE INVENTION

This invention relates to the jacks and lifting devices for furniture, more particularly, a furniture lifting device used for temporarily elevating furniture off the ground, thereby allowing work to be performed under the furniture.

Replacing flooring, such as carpet, wood, linoleum, etc., can be a large undertaking. This is especially true in commercial buildings where large furniture, such as desks, filing cabinets, cubicle walls, etc., is difficult to move without expending large amounts of time and labor. In addition, moving work areas causes lost productivity and thus, lost revenue for a business. Many flooring installers have tried to solve this problem by attempting to install flooring without clearing furniture from a room. One method of doing this is to simply have one or more workers lift a piece of furniture while an installer installs flooring under the furniture. Another method is for one or more workers to use a large crow bar to lift large pieces of furniture so that an installer can install flooring underneath. These conventional methods require extra manpower and oftentimes cause damage to the furniture. For example, the use of a crow bar can break furniture by chipping the furniture at the point of contact between the crow bar and the furniture. In addition, conventional methods make it difficult to evenly elevate a piece of furniture off the ground. If a piece of furniture is not elevated evenly, then the furniture can break and/or objects, such as computers, printers, etc., can fall off the furniture and break.

Therefore, a need exists for a furniture lifting device that will allow a flooring installer to easily and safely lift furniture off the ground so that flooring can be installed underneath.

The relevant prior art includes the following patent references:

| Patent/Serial | | Issue/ |
|---|---|---|
| No. | Inventor | Publication Date |
| 6,997,424 | Atkinson, Jr. | Feb. 14, 2006 |
| 2005/0211961 | Edwards | Sep. 29, 2005 |
| 2004/0182980 | Atkinson, Jr. | Sep. 23, 2004 |
| 6,471,187 | Dube et al. | Oct. 29, 2002 |
| 6,272,853 | Broechmann | Aug. 14, 2001 |
| 6,079,696 | Bette | Jun. 27, 2000 |
| 6,015,135 | Dube et al. | Jan. 18, 2000 |
| 6,009,927 | Peters | Jan. 04, 2000 |
| 5,947,449 | Dube et al. | Sep. 07, 1999 |
| 5,915,670 | Cain | Jun. 29, 1999 |
| 5,385,335 | Wurdack | Jan. 31, 1995 |
| 5,229,779 | Collins | Apr. 05, 1994 |
| 5,261,643 | Wurdack | Nov. 16, 1993 |
| 5,181,694 | Collins | Jan. 26, 1993 |
| 5,141,204 | Marosy | Aug. 25, 1992 |
| 5,127,693 | Pruit | Jul. 07, 1992 |
| 3,942,813 | Dombroski | Mar. 09, 1976 |
| 2,859,012 | Oleson et al. | Nov. 04, 1958 |
| 2,262,918 | Brown | Nov. 18, 1941 |

### SUMMARY OF THE INVENTION

The primary object of the present invention is to provide a furniture lifting device that will allow a flooring installer to easily and safely elevate furniture off the ground so that flooring can be installed underneath.

Another object of the present invention is to provide a furniture lifting device that will reduce the amount of man power required to lift furniture when installing flooring.

A further object of the present invention is to provide a furniture lifting device that will reduce the amount of time required to replace flooring under furniture.

Another object of the present invention is to provide a furniture lifting device that will reduce the possibility of damaging furniture that is being lifted.

The present invention fulfills the above and other objects by providing furniture lifting device comprising a device base having a rear portion and a substantially U-shaped front portion extending forward from the rear portion. The device base is removably attachable to a stabilizer plate that increases the surface area of the device base, thereby making it less likely that the furniture lifting device can tip over during use. A jack allows a user to raise and lower furniture on the furniture lifting device. The jack extends upward from the rear portion of the device base. A handle located on the furniture lifting device allows a user to easily pull or push the device from or into place. A guide located on the jack extends forward towards the front portion of the device base. A bracket, which is preferably substantially U-shaped, is slidably attached to the guide. A foot extends from a bottom end of the bracket towards the front portion of the device base so that the foot is perpendicular to the bracket. The foot may be placed under the edge of a piece of furniture in order to lift the furniture off the ground. The foot is preferably substantially U-shaped so that it can be placed around objects, such as feet of a cubicle wall, when lifting furniture. A substantially tubular post extends upward from the top of the bracket and the jack. The post may be placed under furniture, such as table tops or desk tops, in order to lift the furniture off the ground. For example, the post may be placed under the edge of a conference room table top so that a user can lift the table off the ground. An extension arm located inside of the tubular post telescopes out of the post, thereby allowing a user to adjust the height of the device to accommodate taller pieces of furniture. A plurality of apertures are located on the extension arm and on the post. The extension arm may be locked in place by placing a pin through corresponding apertures on the post and the extension arm. Spacers located on sides of the extension arm keep the extension arm in a centered position within the post. A cap located on top of the extension arm provides a larger surface on top of the extension arm for contacting the underside of a piece of furniture. A spacer extends forward from the post. A spacer extends forward from the post. The spacer provides a contact point for a side of a piece of furniture to lean against while being lifted off of the ground.

Additional features of the furniture lifting device are extension feet that adapt the foot to the furniture lifting device to different sizes and shapes of furniture.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a perspective plan side view of a furniture lifting device of the present invention;

FIG. 2 is a side partial cutaway plan view of a furniture lifting device of the present invention in an elevated position;

FIG. 3 is a front partial cutaway view of a furniture lifting device of the present invention in an elevated position;

FIG. 4 is a cross-section view along line 4-4 of FIG. 2 showing a furniture lifting device of the present invention;

FIG. 5 is a perspective side view of a stabilizer plate;

FIG. 6 is a perspective side view of a L-shaped extension foot;

FIG. 7 is a rear view of a L-shaped extension foot;

FIG. 8 is a perspective side view of a flat extension foot;

FIG. 9 is a rear view of a flat extension foot; and

FIG. 10 is a side perspective view of an extension tool.

### DESCRIPTION OF THE PREFERRED EMBODIMENTS

For purposes of describing the preferred embodiment, the terminology used in reference to the numbered components in the drawings is as follows:

| | |
|---|---|
| 1. | furniture lifting device |
| 2. | device base |
| 3. | rear portion of device base |
| 4. | U-shaped front portion of |
| | device |
| 5. | stabilizer plate |
| 6. | jack |
| 7. | jack base |
| 8. | reservoir |
| 9. | pump |
| 10. | piston |
| 11. | release valve |
| 12. | handle |
| 13. | guide |
| 14. | bracket |
| 15. | foot |
| 16. | bottom end of bracket |
| 17. | post |
| 18. | spacer |
| 19. | bottom end of post |
| 20. | attachment means |
| 21. | cross member |
| 22. | top end of bracket |
| 23. | extension arm |
| 24. | aperture |
| 25. | pin |
| 26. | spacer |
| 27. | cap |
| 28. | recessed area |
| 29. | locking means |
| 30. | slotted tab |
| 31. | L-shaped extension foot |
| 32. | attachment bracket |
| 33. | slot |
| 34. | flat extension foot |
| 35. | lifting means |
| 36. | jack handle |
| 37. | cubicle wall |
| 38. | table top |
| 39. | extension tool |

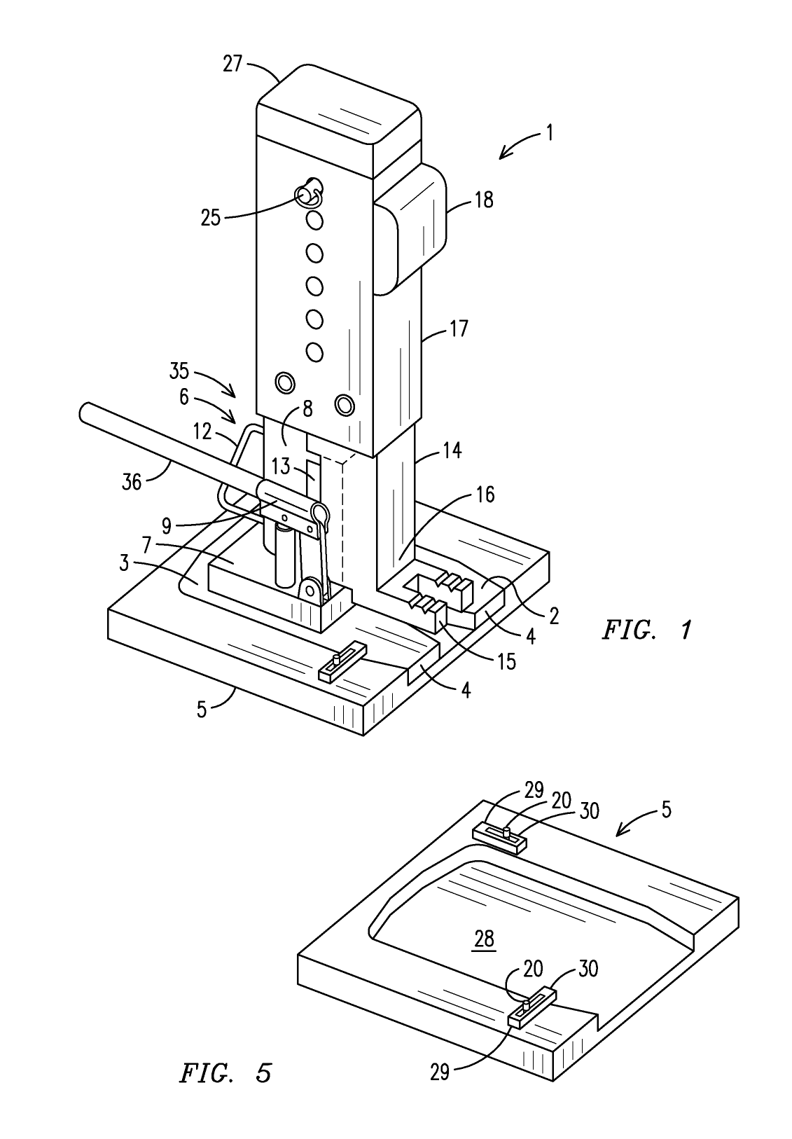

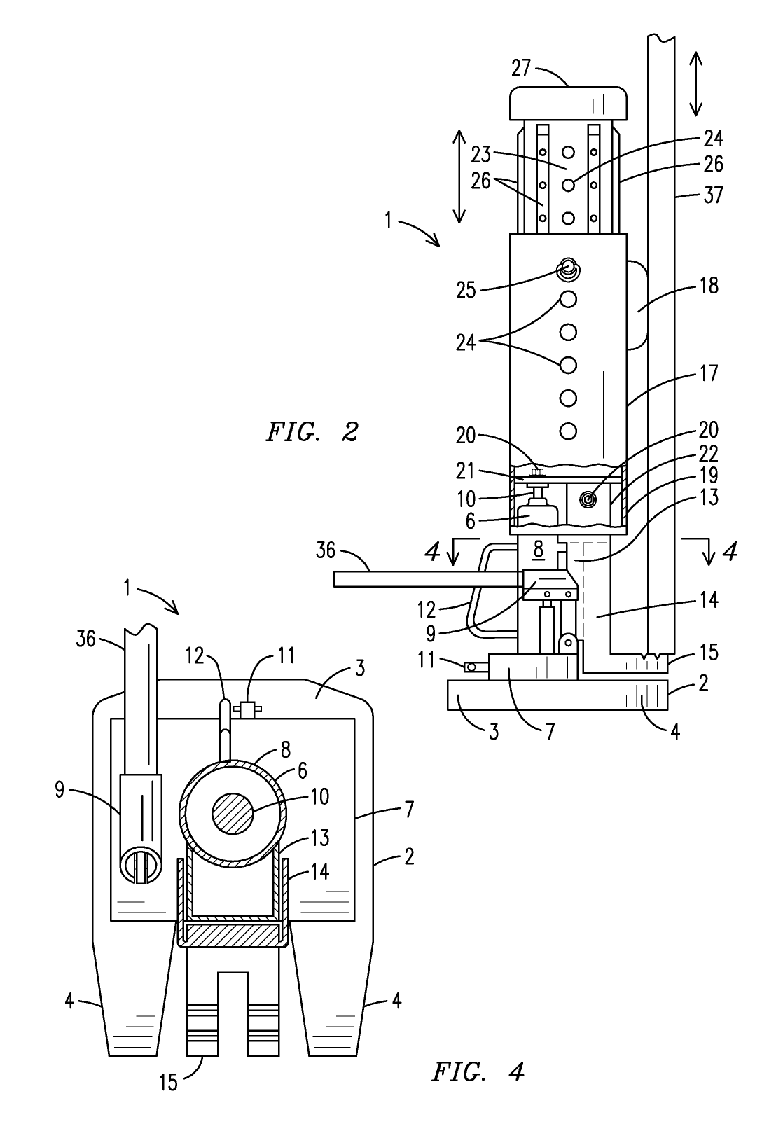

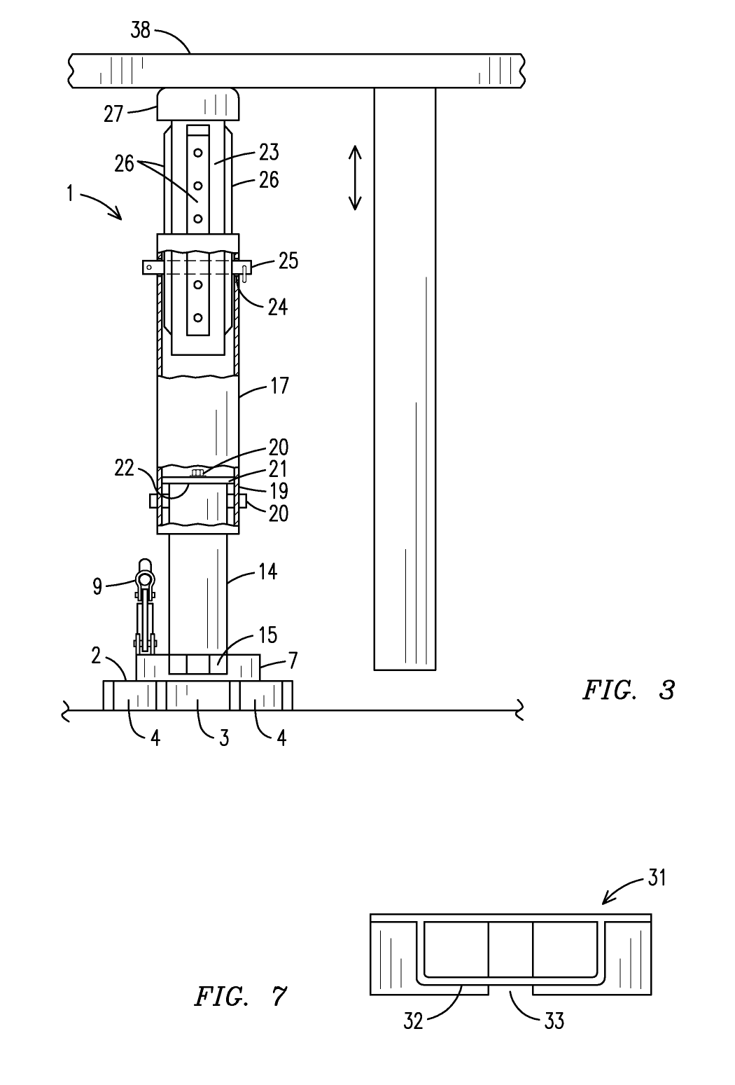

With reference to FIG. 1, a perspective plan side view of a furniture lifting device 1 of the present invention is shown. The furniture lifting device 1 comprises a device base 2 having a rear portion 3 and a substantially U-shaped front portion 4 extending forward from the rear portion 3. As shown here, the device base 2 is removably attached to a stabilizer plate 5 as shown and described further in FIG. 5. A lifting means 35, such as a hydraulic jack 6, a scissor jack, a house jack, a bottle jack, a pnuematic jack, etc. allows a user to raise and lower furniture on the furniture lifting device 1. As described and shown here, the lifting means 35 is a hydraulic jack 6 comprising a jack base 7, a reservoir 8, a pump 9, a piston 10 (as shown in FIG. 2) and a release valve 11 (as shown in FIG. 2), and a jack handle 36. The jack 6 extends upward from the rear portion 3 of the device base 2. A handle 12 located on the furniture lifting device 1 allows a user to easily pull or push the device 1 into a position of use. A guide 13 located on the jack 6 extends forward towards the front portion 4 of the device base 2. A bracket 14, which is preferably substantially U-shaped, is slidably attached to the guide 13. A foot 15 extends from a bottom end 16 of the bracket 14 towards the front portion 4 of the device base 2 so that the foot 15 is perpendicular to the bracket 14. The foot 15 may be placed under the edge of a piece of furniture in order to lift the furniture off of the ground. The foot 15 is preferably substantially U-shaped so that it can be place around objects, such as feet of a cubicle wall, when lifting furniture. A substantially tubular post 17 extends upward from the top of the bracket 14 and the jack 6. The post 17 may be placed under a part of furniture, such as table tops or desk tops, in order to lift the furniture off of the ground. For example, the post 17 may be placed under the edge of a conference room table top so that a user can lift the table off the ground. In addition, the height of the post 17 may be adjusted to accommodate taller pieces of furniture, as shown and further described in FIGS. 2 and 3. A spacer 18 extends forward from the post 17. The spacer 18 provides a contact point for a side of a piece of furniture to lean against while being lifted off the ground.

With reference to FIGS. 2 and 3, a side partial cutaway plan view of a furniture lifting device 1 of the present invention in an elevated position and a front partial cutaway view of a furniture lifting device 1 of the present invention in an elevated position, respectively, are shown. The furniture lifting device 1 comprises a device base 2 having a rear portion 3 and a front portion 4 extending forward from the rear portion 3. A hydraulic jack 6 comprising a jack base 7, a reservoir 8, a pump 9, a piston 10 and a release valve 11 and a jack handle 36 allows a user to raise and lower furniture on the furniture lifting device 1. The jack 6 extends upward from the rear portion 3 of the device base 2. A handle 12 located on the furniture lifting device 1 allows a user to easily pull or push the device 1 out of or into place. A guide 13 located on the jack 6 extends forward towards the front portion 4 of the device base 2. A bracket 14, which is preferably substantially U-shaped, is slidably attached to the guide 13. A foot 15 extends from a bottom end 16 of the bracket 14 towards the front portion 4 of the device base 2 so that the foot 15 is perpendicular to the bracket 14. The foot 15 may be placed under the edge of a piece of furniture, such as a cubicle wall 37 as shown in FIG. 2, in order to lift the furniture off of the ground. The jack 6 and bracket 14 extend upward inside a bottom end 19 of a tubular post 17 and are attached to the tubular post 17 via attachment means 20, such as screws, nuts, bolts, rivets, welds, etc. A cross member 21 is located inside the tubular post 17 to provide extra support against a top end 22 of the bracket 14 and the piston 10 of the jack 6. The cross member 21 also provides an attachment point for attaching the piston 10 of the jack 6 to the tubular post 17. An extension arm 23 located inside of the tubular 17 post telescopes from the post 17, thereby allowing a user to adjust the height of the device 1 to accommodate taller pieces of furniture. For example, the post 17 may be placed under the edge of a conference room table top 38, as shown in FIG. 3, so that a user can lift the table off the ground. A plurality of apertures 24 are located on the extension arm 23 and on the post 17. The extension arm 23 may be locked in place by placing a pin 25 through corresponding apertures 24 on the post 17 and the extension arm 23. Spacers 26 located on sides of the extension arm 23 keep the extension arm 23 in a centered position within the post 17. A cap 27 located on top of the extension arm 23 provides a larger surface on top of the extension arm 23 for contacting the underside of a piece of furniture. A spacer 18 extends forward from the post 17.

With reference to FIG. 4, a cross-section view along line 4-4 of FIG. 2 showing a furniture lifting device 1 of the present invention is shown. The furniture lifting device 1 comprises a device base 2 having a rear portion 3 and a substantially U-shaped front portion 4 extending forward from the rear portion 3. A hydraulic jack 6 comprising a jack base 7, a reservoir 8, a pump 9, a piston 10 and a release valve 11 allows a user to raise and lower furniture on the furniture lifting device 1. The jack 6 extends upward from the rear portion 3 of the device base 2. A handle 12 located on the furniture lifting device 1 allows a user to easily pull or push the device 1 into or from a place of use. A guide 13 located on the jack 6 extends forward towards the front portion 4 of the device base 2. A bracket 14, which is preferably substantially U-shaped, is slidably attached to the guide 13. A foot 15 extends from a bottom end 16 of the bracket 14 towards the front portion 4 of the device base 2 so that the foot 15 is perpendicular to the bracket 14. The foot 15 may be placed under the edge of a piece of furniture in order to lift the furniture off of the ground. The foot 15 is preferably substantially U-shaped so that it can be place around objects, such as feet of a cubicle wall, when lifting furniture.

With reference to FIG. 5, a perspective side view of a stabilizer plate 5 is shown. The stabilizer plate 5 is removably attachable to the device base 2 of the lifting device 1. The stabilizer plate 5 is used to increase the surface area of the device base 2, thereby making it less likely that the furniture lifting device 1 can fall over during use. The stabilizer plate 5 is substantially rectangular-shaped and has a recessed area 28 that the device base 2 sits in. Locking means 29, such as slotted tabs 30 attached to the stabilizer plate with attachment means, 20, lock the base in the stabilizer plate.

With reference to FIGS. 6 and 7, a perspective side view of a L-shaped extension foot 31 and a rear view of a L-shaped extension foot 31, respectively, are shown. The L-shaped extension foot 31 attaches to the foot 15 of the furniture lifting device 1 via an attachment bracket 32 that the foot 15 of the furniture lifting device 1 is inserted into. The L-shaped extension foot 31 allows a user to lift furniture when there is a very small amount of space between the floor and the furniture. A slot 33 in the L-shaped extension foot 31 allows a user to place the L-shaped extension foot 31 around objects, such as feet of a cubicle wall, when lifting furniture.

With reference to FIGS. 8 and 9, a perspective side view of a flat extension foot 34 and a rear view of a flat extension foot 34, respectively, are shown. The flat extension foot 34 attaches to the foot 15 of the furniture lifting device 1 via an attachment bracket 32 that the foot 15 of the furniture lifting device 1 is inserted into. The flat extension foot 34 allows a user to increase the surface area of the foot to decrease the likelihood of damaging furniture.

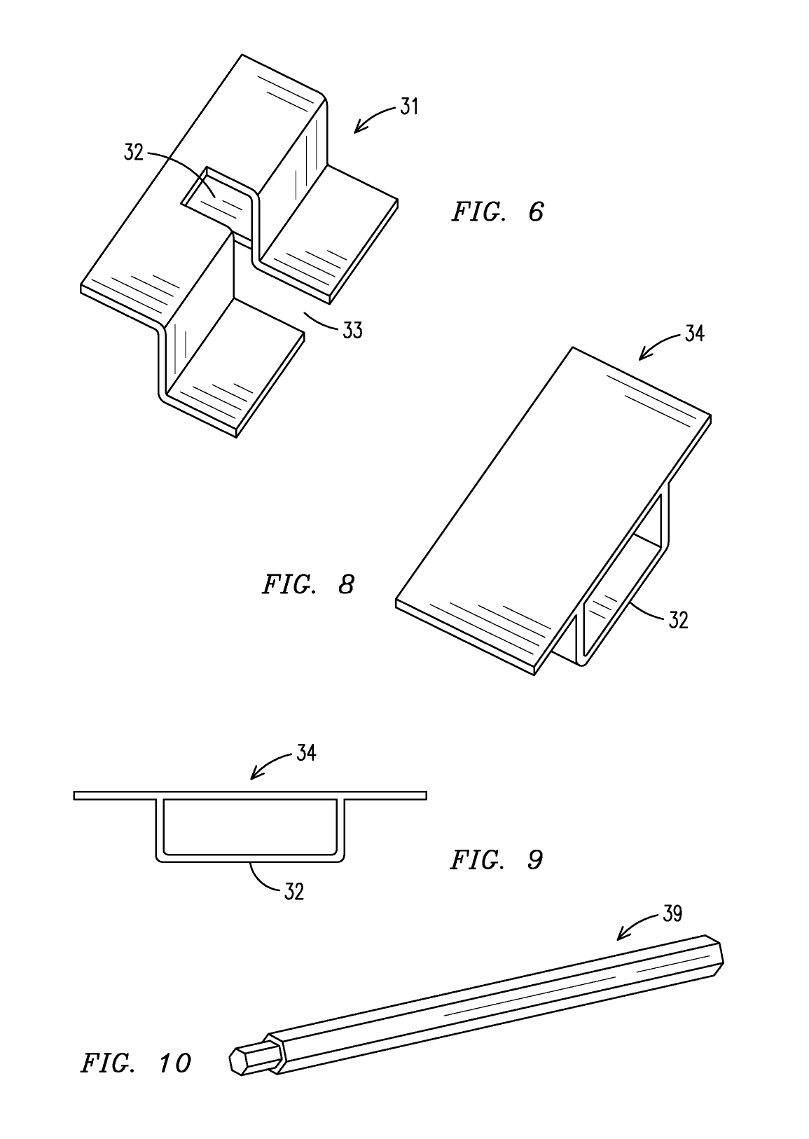

Finally with reference to FIG. 10, a side perspective view of an extension tool 39 is shown. The extension tool 39 may be used to remove the post 17 from the jack 6 by placing the extension tool 39 through the top of the post 17, engaging the attachment means 20 and removing the cross member 21 from the piston 10 of the jack 6 (as shown in FIG. 2).

It is to be understood that while a preferred embodiment of the invention is illustrated, it is not to be limited to the specific form or arrangement of parts or use herein described and shown. It will be apparent to those skilled in the art that various changes may be made without departing from the scope of the invention and the invention is considered not to be limited to what is shown and described in the specification and drawings.

Having thus described my invention, I claim:

1. A furniture lifting device comprising:
a lifting means extending upward from a base for raising and lowering the furniture lifting device;
a guide extending forward from the lifting means;
a bracket having a top end and a bottom end slidably connected to the guide;
a foot extending in a forward direction from the bottom end of the bracket perpendicular to the bracket; and
a post attached to the top end of the bracket.

2. The furniture lifting device of claim 1 wherein:
said post is substantially tubular shaped.

3. The furniture lifting device of claim 2 wherein:
said post further comprises an extension arm located within the post that is extendable out of a top end of the post.

4. The furniture lifting device of claim 3 wherein:
said post further comprises at least one aperture located on a side of the post for locking the extension arm in place with a pin; and
said extension arm further comprises at least one aperture located on a side of the extension arm for locking the extension arm in place with a pin.

5. The furniture lifting device of claim 3 wherein:
at least one spacer is located on a side of the extension arm for keeping the extension arm centered within the post.

6. The furniture lifting device of claim 3 wherein:
a cap is located on a top end of the extension arm.

7. The furniture lifting device of claim 3 wherein:
a cross member is located within the post.

8. The furniture lifting device of claim 1 wherein:
said base further comprises a rear portion and a substantially U-shaped front portion.

9. The furniture lifting device of claim 1 wherein:
said foot is substantially U-shaped.

10. The furniture lifting device of claim 1 further comprising:
a handle located on the furniture lifting device that allows a user to easily pull or push the device out of or into place.

11. The furniture lifting device of claim 1 further comprising:
a spacer located on the post that provides a contact point for a side of a piece of furniture to lean against while being lifted off of the ground by the furniture lifting device.

12. The furniture lifting device of claim 1 further comprising:
a stabilizer plate removably attachable to the base.

13. The furniture lifting device of claim 12 wherein:
wherein the stabilizer plate further comprises a recessed area for the base to sit in.

14. The furniture lifting device of claim 12 wherein:
wherein the stabilizer plate further comprises a locking means for locking the base to the stabilizer plate.

15. The furniture lifting device of claim 1 wherein:
said jack further comprises a jack base located between the base of the furniture lifting device and the jack.

16. The furniture lifting device of claim 1 further comprising:
a L-shaped extension foot that is removably attachable to the foot.

17. The furniture lifting device of claim 16 further comprising:
a slot located on the L-shaped extension foot.

18. The furniture lifting device of claim 1 further comprising:
a flat extension foot that is removably attachable to the foot.

19. The furniture lifting device of claim 1 wherein:
said lifting means is a hydraulic jack.

20. The furniture lifting device of claim 19 wherein said hydraulic jack further comprises:
a reservoir;
a piston located inside the reservoir and extending out of a top end of the reservoir;
a pump connected to the reservoir for moving the piston in an upward direction;
a jack handle attached to the pump for operating the pump; and
a release valve connected to the reservoir for moving the piston in a downward direction.
